(19) United States
(12) Patent Application Publication
(10) Pub. No.: US 2025/0123473 A1
(43) Pub. Date: Apr. 17, 2025

(54) ZOOM LENS AND IMAGING APPARATUS INCLUDING THE SAME

(71) Applicant: CANON KABUSHIKI KAISHA, Tokyo (JP)

(72) Inventor: SHUNJI IWAMOTO, Tochigi (JP)

(21) Appl. No.: 18/912,374

(22) Filed: Oct. 10, 2024

(30) Foreign Application Priority Data
Oct. 16, 2023 (JP) 2023-178514

(51) Int. Cl. G02B 15/14; G02B 13/18; G02B 15/20

(52) U.S. Cl. CPC G02B 15/145523; G02B 13/18; G02B 15/20

(57) ABSTRACT

A zoom lens includes, in order from an object side to an image side, a first lens unit having negative refractive power, a second lens unit having positive refractive power, a third lens unit having positive refractive power, a fourth lens unit having negative refractive power, and a fifth lens unit having positive refractive power, wherein an interval between the lens units adjacent to each other is changed in zooming, and wherein the first lens unit and the fourth lens unit are not moved in zooming.

### BACKGROUND

### Technical Field

The aspect of the embodiments relates to a zoom lens suitable for a digital video camera, a digital still camera, a broadcast camera, a silver-halide film camera, a monitoring camera, and the like.

### Description of the Related Art

In a zoom lens used in an imaging apparatus, when mass or a moving amount of a lens unit moved in zooming or the number of lens units moved in zooming is increased, the zoom lens is likely to have a large size.

Japanese Patent Application Laid-Open No. 2017-078768 discusses a zoom lens including a negative first lens unit, a positive second lens unit, a positive third lens unit, a negative fourth lens unit, and a positive fifth lens unit in order from an object side. In zooming, the first lens unit and the fourth lens unit are not moved.

### SUMMARY

According to an aspect of the embodiments, a zoom lens includes, in order from an object side to an image side, a first lens unit having negative refractive power, a second lens unit having positive refractive power, a third lens unit having positive refractive power, a fourth lens unit having negative refractive power, and a fifth lens unit having positive refractive power, wherein an interval between the lens units adjacent to each other is changed in zooming, and wherein the first lens unit and the fourth lens unit are not moved in zooming.

Further features of the embodiments will become apparent from the following description of exemplary embodiments with reference to the attached drawings.

### BRIEF DESCRIPTION OF THE DRAWINGS

FIG. 1 is a cross-sectional view of a zoom lens according to a first exemplary embodiment.

FIGS. 2A and 2B are aberration diagrams at a wide angle end and a telephoto end of the zoom lens according to the first exemplary embodiment when focus is at infinity.

FIG. 3 is a cross-sectional view of a zoom lens according to a second exemplary embodiment.

FIGS. 4A and 4B are aberration diagrams at a wide angle end and a telephoto end of the zoom lens according to the second exemplary embodiment when focus is at infinity.

FIG. 5 is a cross-sectional view of a zoom lens according to a third exemplary embodiment.

FIGS. 6A and 6B are aberration diagrams at a wide angle end and a telephoto end of the zoom lens according to the third exemplary embodiment when focus is at infinity.

FIG. 7 is a cross-sectional view of a zoom lens according to a fourth exemplary embodiment.

FIGS. 8A and 8B are aberration diagrams at a wide angle end and a telephoto end of the zoom lens according to the fourth exemplary embodiment when focus is at infinity.

FIG. 9 is a schematic diagram of an imaging apparatus.

### DESCRIPTION OF THE EMBODIMENTS

Exemplary embodiments of the disclosure are described below with reference to the drawings. The drawings may be drawn on a scale different from an actual scale for convenience's sake. In the drawings, the same members are denoted by the same reference numerals, and repetitive description is omitted.

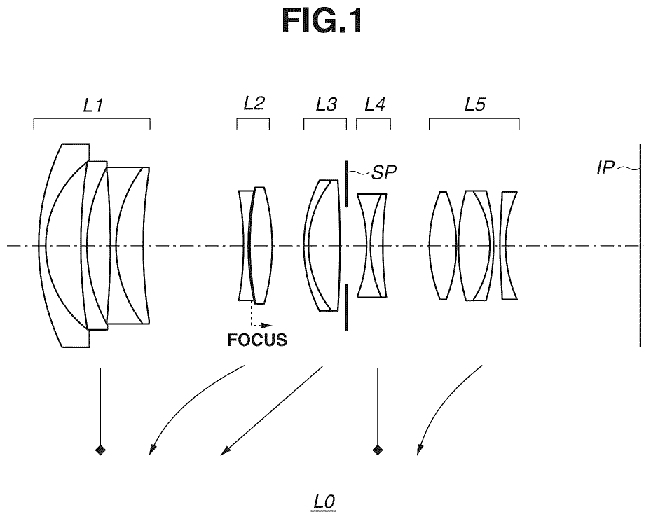

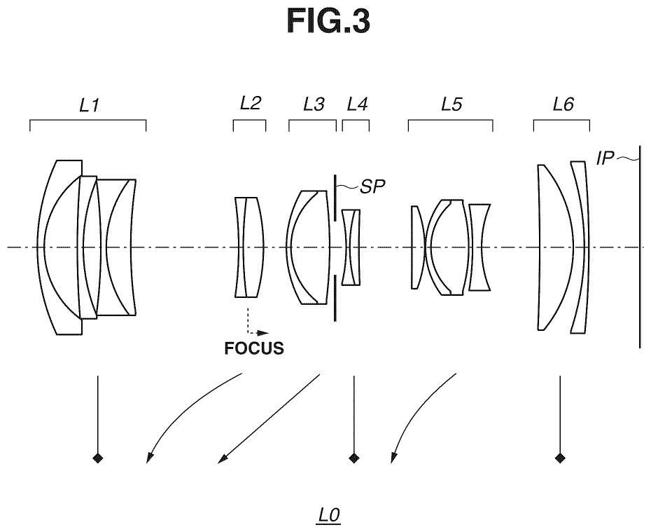

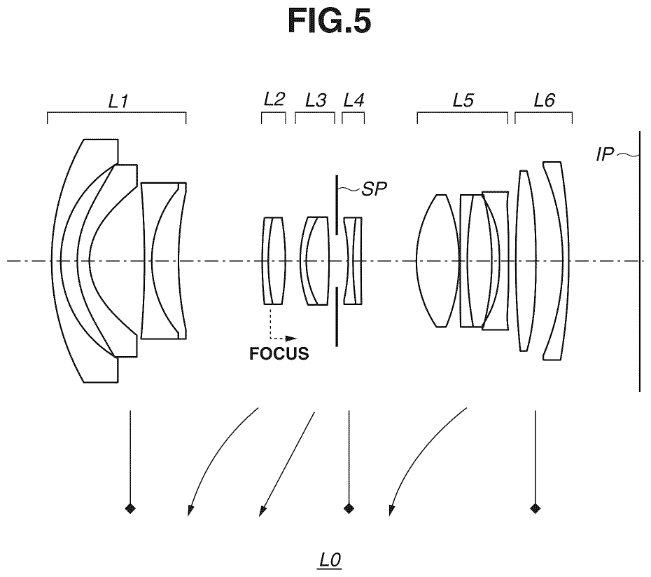

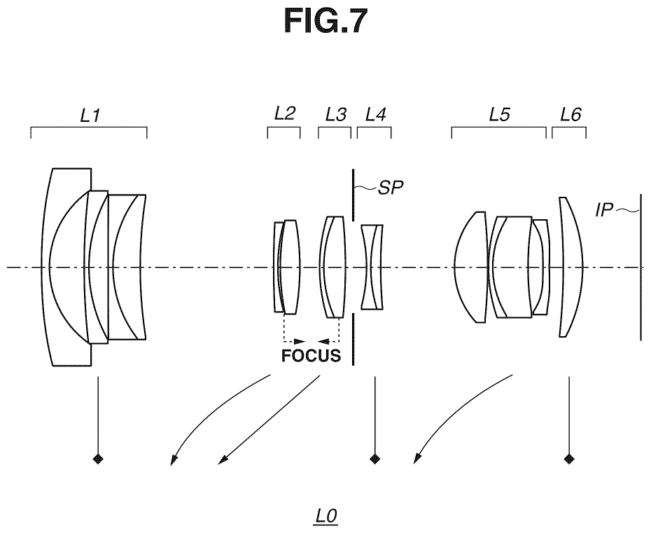

FIGS. 1, 3, 5, and 7 are cross-sectional views of zoom lenses L0 at a wide angle end when focus is at infinity according to first to fourth exemplary embodiments. In each of the drawings, a left side is an object side (front side), and a right side is an image side (rear side). The zoom lens L0 according to each of the exemplary embodiments includes a plurality of lenses. The zoom lens L0 according to each of the exemplary embodiments includes a plurality of lens units, and intervals between adjacent lens units are varied in zooming. Each of the lens units may include one lens, or may include a plurality of lenses.

In each of the diagrams, Li indicates an i-th (i is a natural number) lens unit counted from the object side among the lens units included in the zoom lens L0.

In each of the drawings, SP indicates an aperture stop, and IP indicates an image plane. When the zoom lens L0 according to each of the exemplary embodiments is used as an imaging optical system of a digital video camera or a digital still camera, an image pickup plane of a solid-state image pickup device (photoelectric conversion device) is disposed on an image plane IP. As the solid-state image pickup device, a charge-coupled device (CCD) sensor, a complementary metal-oxide semiconductor (CMOS) sensor, or the like can be used. When the zoom lens according to each of the exemplary embodiments is used as an imaging optical system of a silver-halide film camera, a photosensitive surface of a film is disposed on the image plane IP.

In each of the drawings, each solid arrow indicates a locus of movement of each of the lens units in zooming from a wide angle end to a telephoto end, and solid arrows are illustrated below the lens units moving in an optical axis direction in zooming.

In each of the drawings, each dashed arrow indicates a locus of movement of each of the lens units in focusing from infinity to a close distance (closest end), and dashed arrows are illustrated below the lens unit moving in focusing.

The zoom lens L0 according to each of the exemplary embodiments may function as an image stabilizing optical system by making one or a plurality of lenses eccentric so as to include a component perpendicular to an optical axis in image shake correction. A plane-parallel plate that has substantially no refractive power, such as a low-pass filter and an infrared cut filter, may be disposed between a lens disposed on a most image side and the image plane.

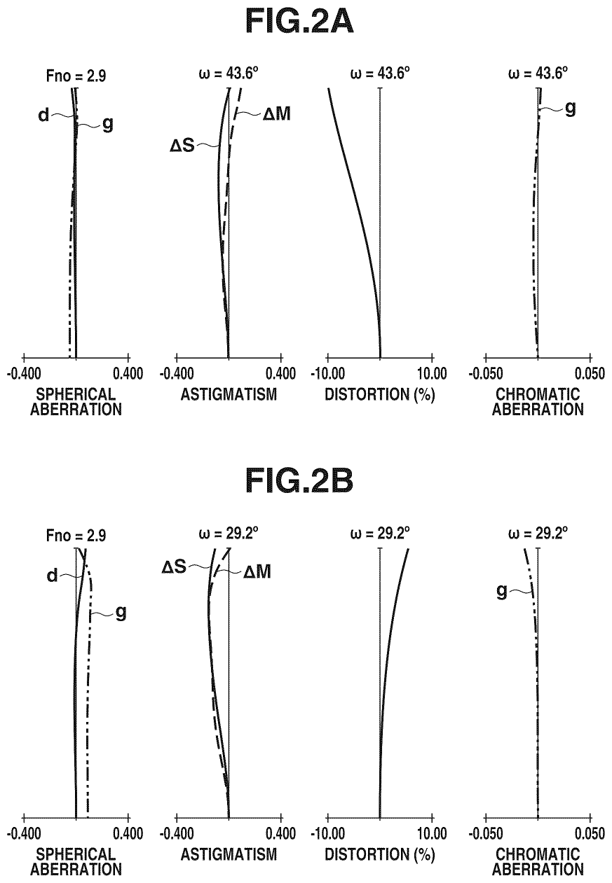

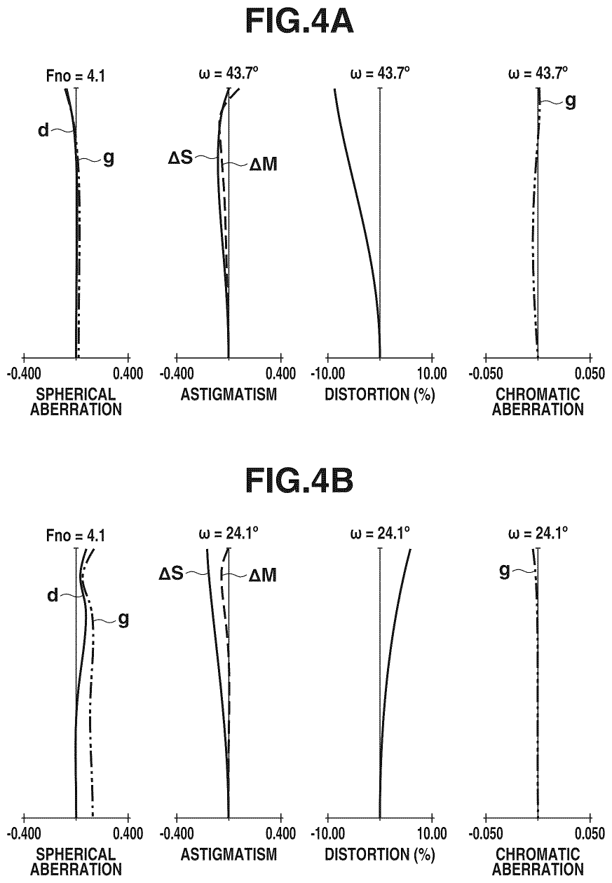

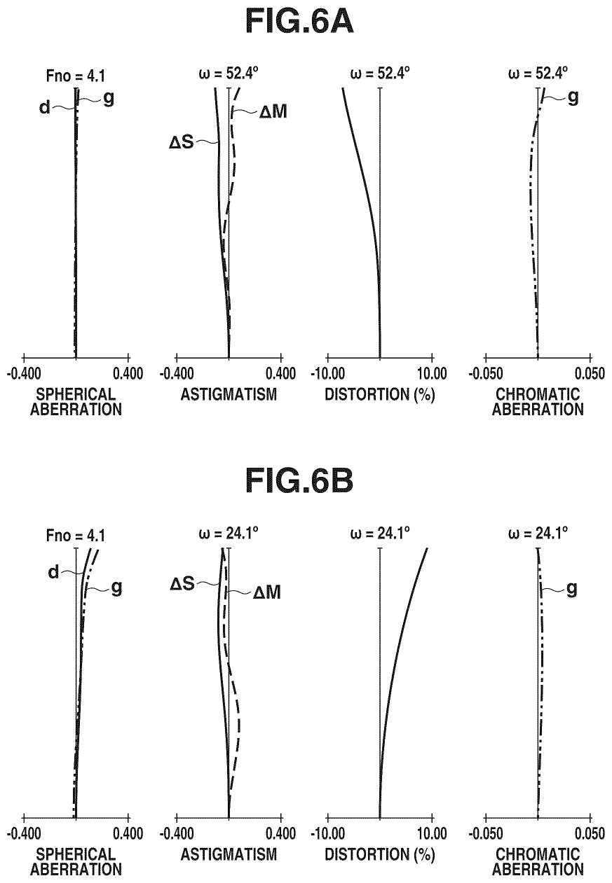

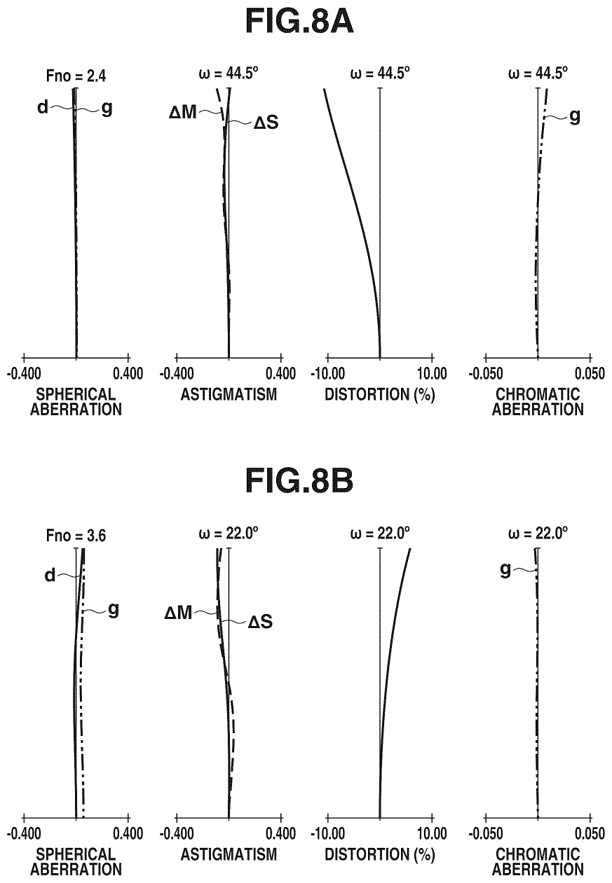

FIGS. 2A and 2B, 4A and 4B, 6A and 6B, and 8A and 8B are aberration diagrams at the wide angle end and the telephoto end of the zoom lenses according to the first to fourth exemplary embodiments when focus is at infinity.

In each of the drawings, Fno indicates an F-number, and @ indicates an imaging half angle of view (degree) determined from paraxial calculation. In a spherical aberration diagram, a solid line indicates spherical aberration for a d-line (wavelength of 587.56 nm), and an alternate long and two short dashes line indicates spherical aberration for a g-line (wavelength of 435.835 nm). In an astigmatism diagram, a solid line indicates astigmatism for the d-line on a sagittal image plane, and a dashed line indicates astigmatism for the d-line on a meridional image plane. A distortion diagram illustrates distortion for the d-line. A chromatic aberration diagram illustrates magnification chromatic aberration for the g-line.

A characteristic configuration of the zoom lens L0 according to each of the exemplary embodiments is described. The zoom lens L0 according to each of the exemplary embodiments is a zoom lens including a negative first lens unit L1, a positive second lens unit L2, a positive third lens unit L3, a negative fourth lens unit L4, and a positive fifth lens unit L5 disposed in order from the object side to the image side. In zooming, the first lens unit L1 and the fourth lens unit L4 are not moved.

Next, conditions satisfied by the zoom lens L0 according to each of the exemplary embodiments are described.

When an absolute value of a moving amount of the second lens unit L2 on the optical axis in zooming from the wide angle end to the telephoto end is denoted by M2, a focal length of the entire system at the wide angle end when focus is at infinity is denoted by fw, a focal length of the third lens unit L3 is denoted by f3, and a focal length of the fourth lens unit L4 is denoted by f4, the following inequalities (1) and (2) are satisfied. The moving amount of the lens unit is equivalent to a difference between a position on the optical axis at the wide angle end and a position on the optical axis at the telephoto end. A sign of the moving amount is positive when the lens unit is positioned on the image side at the telephoto end as compared with at the wide angle end.

$$0.45 < M 2 / fw < 4 \text{.50} \qquad ( 1 )$$

$$0. < \vert f 3 / f 4 \vert < 1.7 \qquad ( 2 )$$

The inequality (1) defines a relationship between the moving amount of the second lens unit L2 on the optical axis and the focal length at the wide angle end. When a value exceeds an upper limit value of the inequality (1), the moving amount of the second lens unit L2 becomes excessively large. As a result, the optical system is likely to have a large size, or high-speed zoom operation is likely to be difficult. In contrast, when the value is lower than a lower limit value of the inequality (1), achievement of a high zoom ratio is likely to be difficult.

The inequality (2) defines a relationship between the focal length of the third lens unit L3 and the focal length of the fourth lens unit L4. When a value exceeds an upper limit value of the inequality (2), divergence of a light flux in the third lens unit L3 becomes excessively high. As a result, suppression of increase in lens diameter of a lens disposed on the image side relative to the third lens unit L3 is likely to be difficult.

Further, in one embodiment, numerical ranges of the inequalities (1) and (2) are set to numerical ranges of the following inequalities (1a) and (2a).

$$0.61 < M 2 / fw < 3 \text{.20} \qquad ( 1 a )$$

$$0.2 < \vert f 3 / f 4 \vert < 1.39 \qquad ( 2 a )$$

Further, in another embodiment, numerical ranges of the inequalities (1a) and (2a) are set to numerical ranges of the following inequalities (1b) and (2b).

$$0.69 < M 2 / fw < 2 \text{.55} \qquad ( 1 b )$$

$$0.45 < \vert f 3 / f 4 \vert < 1.23 \qquad ( 2 b )$$

When the value is lower than lower limit values of the inequalities (2a) and (2b), a zooming effect of the fourth lens unit L4 is reduced, and achievement of a high zoom ratio is likely to be difficult.

Next, conditions satisfied by the zoom lens L0 according to each of the exemplary embodiments are described.

The third lens unit L3 according to each of the exemplary embodiments includes an aperture stop SP, and the aperture stop SP is moved integrally with the third lens unit L3 in zooming. With such a configuration, increase in lens diameter of each of the lens units and mass of the moving lens unit are easily suppressed.

The first lens unit L1 according to each of the exemplary embodiments includes three negative lenses. When power is distributed to the three negative lenses, various aberrations, in particular, distortion aberration at the wide angle end is easily corrected.

The fourth lens unit L4 according to each of the exemplary embodiments includes a negative lens with a concave surface facing the object side. When the negative lens with the concave surface facing the object side is disposed, zoom variation of spherical aberration is easily suppressed.

The fifth lens unit L5 according to each of the exemplary embodiments includes two positive lenses. When power is distributed to the two positive lenses, various aberrations, in particular, zoom variation of astigmatism is easily corrected.

The second lens unit L2 according to each of the exemplary embodiments is moved in focusing from infinity to a close distance. When the second lens unit L2 is moved, aberration correction in focusing is easily performed, and in particular, spherical aberration at the telephoto end in focusing on the close distance is easily corrected.

The first lens unit L1 according to each of the exemplary embodiments is not moved relative to the image plane IP in focusing. When the first lens unit L1 that is likely to have a large lens diameter and large mass is not moved in focusing, a driving mechanism can be simplified.

The zoom lens L0 according to each of the exemplary embodiments satisfies one or more of the following inequalities (3) to (15).

A back focus at the wide angle end when focusing an object at infinity is denoted by BFw, the focal length of the entire system at the wide angle end when focus is at infinity is denoted by fw, and the focal length of the entire system at the telephoto end when focusing an object at infinity is denoted by ft. A focal length of the first lens unit L1 is denoted by f1, a focal length of the second lens unit L2 is denoted by f2, the focal length of the third lens unit L3 is denoted by f3, the focal length of the fourth lens unit L4 is denoted by f4, and a focal length of the fifth lens unit L5 is denoted by f5.

An absolute value of a moving amount of the third lens unit L3 on the optical axis in zooming from the wide angle end to the telephoto end is denoted by M3, and an absolute value of a moving amount of the fifth lens unit L5 on the optical axis in zooming from the wide angle end to the telephoto end is denoted by M5. A combined lateral magnification of the second lens unit L2 and the third lens unit L3 at the wide angle end is denoted by BFw, and a combined lateral magnification of the second lens unit L2 and the third lens unit L3 at the telephoto end is denoted by βFt. A combined lateral magnification of the lens units disposed on the image side relative to the third lens unit L3 at the wide angle end is denoted by βRw, and a combined lateral magnification of the lens units disposed on the image side relative to the third lens unit L3 at the telephoto end is denoted by βRt. A distance from the aperture stop SP to a surface of the fourth lens unit on the most object side on the optical axis is denoted by DSPL4t.

$$0.3 < BFw / fw < 3.10 \qquad ( 3 )$$

$$0.6 < \vert f 1 / fw \vert < 3. 60 \qquad ( 4 )$$

$$2. < f 2 / fw < 12.10 \qquad ( 5 )$$

$$1. < f 3 / fw < 7.60 \qquad ( 6 )$$

$$1. < \vert f 4 / fw \vert < 7.6 \qquad ( 7 )$$

$$0.9 < f 5 / fw < 5.90 \qquad ( 8 )$$

$$0.3 < \vert f 1 / f 5 \vert < 1.6 \qquad ( 9 )$$

$$0.2 < \vert f 1 / f 4 \vert < 1.3 \qquad ( 10 )$$

$$0.4 < M 3 / fw < 3.80 \qquad ( 11 )$$

$$0.2 < M 5 / fw < 2.10 \qquad ( 12 )$$

$$0.7 < β Ft / β Fw < 4.10 \qquad ( 13 )$$

$$0.5 < β Rt / β Rw < 2.10 \qquad ( 14 )$$

$$0.2 < DSPL4t / ft < 1.5 \qquad ( 15 )$$

The inequality (3) defines a relationship between the back focus and the focal length of the entire system at the wide angle end. When a value exceeds an upper limit value of the inequality (3), the entire system is likely to have a large size. In contrast, when the value is lower than a lower limit value of the inequality (3), an off-axis ray height of the fifth lens unit L5 is increased, and therefore the lens diameter is likely to be increased.

The inequality (4) defines a relationship between the focal length of the first lens unit L1 and the focal length of the entire system at the wide angle end. When a value exceeds an upper limit value of the inequality (4), a diameter of a front lens is likely to be increased.

In contrast, when the value is lower than a lower limit value of the inequality (4), correction of distortion aberration at the wide angle end is likely to be difficult.

The inequality (5) defines a relationship between the focal length of the second lens unit L2 and the focal length of the entire system at the wide angle end. When a value exceeds an upper limit value of the inequality (5), a lens diameter of a lens disposed on the image side relative to the second lens unit L2 is likely to be increased. In contrast, when the value is lower than a lower limit value of the inequality (5), correction of spherical aberration at the telephoto end is likely to be difficult.

The inequality (6) defines a relationship between the focal length of the third lens unit L3 and the focal length of the entire system at the wide angle end. When a value exceeds an upper limit value of the inequality (6), a lens diameter of a lens disposed on the image side relative to the third lens unit L3 is likely to be increased. In contrast, when the value is lower than a lower limit value of the inequality (6), correction of spherical aberration at the telephoto end is likely to be difficult.

The inequality (7) defines a relationship between the focal length of the fourth lens unit L4 and the focal length of the entire system at the wide angle end. When a value exceeds an upper limit value of the inequality (7), correction of spherical aberration at the telephoto end is likely to be difficult. In contrast, when the value is lower than a lower limit value of the inequality (7), a lens diameter of a lens disposed on the image side relative to the fourth lens unit L4 is likely to be increased.

The inequality (8) defines a relationship between the focal length of the fifth lens unit L5 and the focal length of the entire system at the wide angle end. When a value exceeds an upper limit value of the inequality (8), correction of Petzval sum is insufficient, and therefore correction of field curvature is likely to be difficult. In contrast, when the value is lower than a lower limit value of the inequality (8), correction of astigmatism at the wide angle end is likely to be difficult.

The inequality (9) defines a relationship between the focal length of the first lens unit L1 and the focal length of the fifth lens unit L5. When a value exceeds an upper limit value of the inequality (9), Petzval sum is excessively corrected. As a result, correction of field curvature is likely to be difficult. In contrast, when the value is lower than a lower limit value of the inequality (9), correction of Petzval sum is insufficient. As a result, correction of field curvature is likely to be difficult.

The inequality (10) defines a relationship between the focal length of the first lens unit L1 and the focal length of the fourth lens unit L4. When a value exceeds an upper limit value of the inequality (10), a diameter of a front lens is likely to be increased. In contrast, when the value is lower than a lower limit value of the inequality (10), correction of distortion aberration at the wide angle end is likely to be difficult.

The inequality (11) defines a relationship between the moving amount of the third lens unit L3 on the optical axis in zooming from the wide angle end to the telephoto end and the focal length of the entire system at the wide angle end. When a value exceeds an upper limit value of the inequality (11), the optical system is likely to have a large size. In contrast, when the value is lower than a lower limit value of the inequality (11), achievement of a high zoom ratio is likely to be difficult.

The inequality (12) defines a relationship between the moving amount of the fifth lens unit L5 on the optical axis in zooming from the wide angle end to the telephoto end and the focal length of the entire system at the wide angle end. When a value exceeds an upper limit value of the inequality (12), the optical system is likely to have a large size. In contrast, when the value is lower than a lower limit value of the inequality (12), achievement of a high zoom ratio is likely to be difficult.

The inequality (13) defines a ratio of the combined lateral magnification of the second lens unit L2 and the third lens unit L3 at the telephoto end and the wide angle end. When a value exceeds an upper limit value of the inequality (13), suppression of zoom variation of coma aberration occurring on the second lens unit L2 and the third lens unit L3 is likely to be difficult. In contrast, when the value is lower than a lower limit value of the inequality (13), achievement of a high zoom ratio is likely to be difficult.

The inequality (14) defines a ratio of the combined lateral magnification of the lens units disposed on the image side relative to the third lens unit L3 at the telephoto end and the wide angle end. When a value exceeds an upper limit value of the inequality (14), suppression of zoom variation of astigmatism occurring on the lens units disposed on the image side relative to the third lens unit L3 is likely to be difficult. In contrast, when the value is lower than a lower limit value of the inequality (14), achievement of a high zoom ratio is likely to be difficult.

The inequality (15) defines a relationship between the distance from the aperture stop SP to the surface the fourth lens unit L4 on the object side and the focal length of the entire system at the telephoto end. When a value exceeds an upper limit value of the inequality (15), an off-axis ray height of the fifth lens unit L5 at the telephoto end is increased, and therefore the lens diameter is likely to be increased. In contrast, when the value is lower than a lower limit value of the inequality (15), an on-axis ray height of the fourth lens unit L4 at the telephoto end is increased, and therefore correction of spherical aberration occurring on the fourth lens unit L4 is likely to be difficult.

The numerical ranges of the inequalities (3) to (15) are set to numerical ranges of the following inequalities (3a) to (15a).

$$0.45 < BFw / fw < 2.31 \qquad ( 3 a )$$

$$0.9 < \vert f 1 / fw \vert < 2.7 \qquad ( 4 a )$$

$$3.03 < f 2 / fw < 9.08 \qquad ( 5 a )$$

$$1.54 < f 3 / fw < 5.70 \qquad ( 6 a )$$

$$1.48 < \vert f 4 / fw \vert < 5.71 \qquad ( 7 a )$$

$$1.36 < f 5 / fw < 4.44 \qquad ( 8 a )$$

$$0.42 < \vert f 1 / f 5 \vert < 1.2 \qquad ( 9 a )$$

$$0.3 < \vert f 1 / f 4 \vert < 0.97 \qquad ( 10 a )$$

$$0.57 < M 3 / fw < 2.84 \qquad ( 11 a )$$

$$0.31 < M 5 / fw < 1.57 \qquad ( 12 a )$$

$$1.08 < β Ft / β Fw < 3.07 \qquad ( 13 a )$$

$$0.74 < β Rt / β Rw < 1.58 \qquad ( 14 a )$$

$$0.33 < DSPL4t / ft < 1.13 \qquad ( 15 a )$$

The numerical ranges of the inequalities (3) to (15) are further set to numerical ranges of the following inequalities (3b) to (15b).

$$0.52 < BFw / fw < 1.92 \qquad ( 3 b )$$

$$1.05 < \vert f 1 / fw \vert < 2.25 \qquad ( 4 b )$$

$$3.54 < f 2 / fw < 7.57 \qquad ( 5 b )$$

$$1.81 < f 3 / fw < 4.75 \qquad ( 6 b )$$

$$1.72 < \vert f 4 / fw \vert < 4.76 \qquad ( 7 b )$$

$$1.59 < f 5 / fw < 3.71 \qquad ( 8 b )$$

$$0.48 < \vert f 1 / f 5 \vert < 1. \qquad ( 9 b )$$

$$0.35 < \vert f 1 / f 4 \vert < 0.8 \qquad ( 10 b )$$

$$0.66 < M 3 / fw < 2.36 \qquad ( 11 b )$$

$$0.37 < M 5 / fw < 1.3 \qquad ( 12 b )$$

$$1.27 < β Ft / β Fw < 2.55 \qquad ( 13 b )$$

$$0.86 < β Rt / β Rw < 1.32 \qquad ( 14 b )$$

$$0.4 < DSPL 4 t / ft < 0.95 \qquad ( 15 b )$$

The zoom lens L0 according to the first exemplary embodiment includes the first lens unit L1 having negative refractive power, the second lens unit L2 having positive refractive power, the third lens unit L3 having positive refractive power, the fourth lens unit L4 having negative refractive power, and the fifth lens unit having positive refractive power disposed in order from the object side to the image side.

The first lens unit L1 and the fourth lens unit LA are not moved relative to the image plane IP in zooming from the wide angle end to the telephoto end. The second lens unit L2, the third lens unit L3, and the fifth lens unit L5 are moved to the object side in zooming from the wide angle end to the telephoto end. Further, the second lens unit L2 is moved to the image side in focusing from infinity to the close distance.

The first lens unit L1 includes three negative lenses and one positive lens. The fourth lens unit L4 includes a negative lens with a concave surface facing the object side. The fifth lens unit L5 includes a positive lens, a positive lens, a negative lens in a meniscus shape with a convex surface facing the image side, and a negative lens in the meniscus shape with a convex surface facing the object side.

The zoom lens L0 according to the second exemplary embodiment includes the first lens unit L1 having negative refractive power, the second lens unit L2 having positive refractive power, the third lens unit L3 having positive refractive power, the fourth lens unit L4 having negative refractive power, the fifth lens unit L5 having positive refractive power, and a sixth lens unit L6 having positive refractive power disposed in order from the object side to the image side.

The first lens unit L1, the fourth lens unit L4, and the sixth lens unit L6 are not moved relative to the image plane IP in zooming from the wide angle end to the telephoto end. The second lens unit L2, the third lens unit L3, and the fifth lens unit L5 are moved to the object side in zooming from the wide angle end to the telephoto end. The fifth lens unit L5 includes a positive lens in a meniscus shape with a convex surface facing the image side, a negative lens in a meniscus shape with a convex surface facing the object side, a positive lens, and a negative lens in order from the object side to the image side.

The zoom lens L0 according to the third exemplary embodiment includes the first lens unit L1 having negative refractive power, the second lens unit L2 having positive refractive power, the third lens unit L3 having positive refractive power, the fourth lens unit LA having negative refractive power, the fifth lens unit L5 having positive refractive power, and the sixth lens unit L6 having negative refractive power disposed in order from the object side to the image side. The fifth lens unit L5 according to the present exemplary embodiment includes a positive lens, a negative lens in a meniscus shape with a convex surface facing the object side, a positive lens, and a negative lens in a meniscus shape with a convex surface facing the image side in order from the object side to the image side.

The configuration of lens units of the zoom lens L0 according to the fourth exemplary embodiment is similar to the configuration thereof according to the second exemplary embodiment. The fifth lens unit L5 according to the present exemplary embodiment includes a positive lens, a negative lens in a meniscus shape with a convex surface facing the object side, a positive lens in a meniscus shape with a convex surface facing the object side, and a negative lens in a meniscus shape with a convex surface facing the image side in order from the object side to the image side. Further, in focusing from infinity to a close distance, the second lens unit L2 is moved to the image side, and the third lens unit L3 is moved to the object side.

First to fourth numerical examples corresponding to the first to fourth exemplary embodiments are described below.

In surface data in each of the numerical examples, r indicates a radius of curvature of each optical surface, and d (mm) indicates an on-axis interval (distance on optical axis) between an m-th surface and an (m+1)-th surface, where m is a number of a surface counted from a light incident side. Further, nd indicates a refractive index of each optical member relative to a d-line, and vd indicates Abbe number of each optical member. The Abbe number vd of a material is a value defined by the following formula, where refractive indices for the d-line (587.6 nm), an F-line (486.1 nm), a C-line (656.3 nm), and the g-line (435.8 nm) of Fraunhofer lines are denoted by Nd, NF, NC, and Ng, respectively:

$$vd = ( Nd - 1 ) / ( NF - NC ) .$$

In each of the numerical examples, d, a focal length (mm), an F-number, and a half angle of view (degree) are values when the zoom lens L0 according to each of the exemplary embodiments focuses on an infinitely distant object. A back focus BF is a distance from a final lens surface to the image plane. A total optical length is a value obtained by adding the back focus to a distance from a first lens surface to the final lens surface. The lens unit is not limited to a configuration including a plurality of lenses, and also includes a configuration including one lens.

In a case where an optical surface is an aspherical surface, a symbol “*” is added to a right side of a surface number. An aspherical surface shape can be represented by the following formula, where a displacement amount from a surface vertex in the optical axis direction is denoted by X, a height from the optical axis in a direction perpendicular to the optical axis is denoted by h, a paraxial radius of curvature is denoted by R, a conic constant is denoted by K, and aspherical coefficients of respective orders are denoted by A4, A6, A8, A10, and A12. Note that “e±XX” in each of the aspherical coefficients indicates “×10^{±XX}”.

$$X = ( {h}^{2} / R ) / [ 1 + {\{ 1 - ( 1 + K ) {( h / R )}^{2} \}}^{1 / 2} ] + A 4 \times {h}^{4} + A 6 \times {h}^{6} + A 8 \times {h}^{8} + A 10 \times {h}^{10} + A 12 \times {h}^{12}$$

### First Numerical Example

Unit mm
Surface Data

| Surface Number | r | d | nd | vd |
|---|---|---|---|---|
| 1 | 50.138 | 1.50 | 2.00100 | 29.1 |
| 2 | 22.570 | 7.45 | | |
| 3 | 116.355 | 1.30 | 1.59282 | 68.6 |
| 4 | 35.489 | 4.98 | | |
| 5 | −173.357 | 1.20 | 1.49700 | 81.5 |
| 6 | 27.379 | 5.78 | 1.91082 | 35.2 |
| 7 | 103.647 | (Variable) | | |
| 8 | −67.008 | 1.00 | 1.85478 | 24.8 |
| 9 | 55.824 | 0.36 | | |
| 10 | 64.927 | 4.72 | 1.95375 | 32.3 |
| 11* | −46.353 | (Variable) | | |
| 12 | 30.945 | 1.00 | 1.90366 | 31.3 |
| 13 | 22.207 | 6.69 | 1.59522 | 67.7 |
| 14* | −195.735 | 1.37 | | |
| 15(Aperture) | ∞ | (Variable) | | |
| 16* | −31.517 | 0.80 | 1.61340 | 44.3 |
| 17 | 27.386 | 2.64 | 1.92286 | 20.9 |
| 18 | 80.449 | (Variable) | | |
| 19 | 30.011 | 5.74 | 1.49700 | 81.5 |
| 20 | −31.783 | 0.45 | | |
| 21 | 44.726 | 6.67 | 1.49700 | 81.5 |
| 22 | −20.853 | 0.80 | 2.05090 | 26.9 |
| 23 | −44.250 | 1.33 | | |
| 24* | 70.402 | 1.20 | 1.88202 | 37.2 |
| 25* | 27.013 | (Variable) | | |
| Image Plane | ∞ | | | |

Aspherical Surface Data
11-th Surface
K = 0.00000e+00, A4 = −2.12988e−07,
A6 = −1.38481e−09, A8 = −2.96618e−12
14-th Surface
K = 0.00000e+00, A4 = 2.70462e−08,
A6 = 5.91799e−10, A8 = 6.68411e−12
16-th Surface
K = 0.00000e+00, A4 = −6.84993e−07,
A6 = −1.21471e−08, A8 = −2.80284e−11
24-th Surface
K = 0.00000e+00, A4 = −3.85359e−05,
A6 = 1.24853e−07, A8 = −2.07298e−10
25-th Surface
K = −9.43177e+00, A4 = 3.62160e−05,
A6 = −1.14770e−07, A8 = 1.04700e−09,
A10 = −3.45970e−12, A12 = 2.70504e−15
Various Kinds of Data

| | |
|---|---|
| Zoom Ratio | 1.88 |

| | Wide Angle | Intermediate | Telephoto |
|---|---|---|---|
| Focal Length | 20.61 | 29.26 | 38.72 |
| F-number | 2.90 | 2.90 | 2.90 |
| Half Angle | 43.64 | 36.48 | 29.19 |
| of View | | | |
| Image Height | 19.65 | 21.64 | 21.64 |
| Total Lens | 130.70 | 130.70 | 130.70 |
| Length | | | |
| BF | 31.45 | 36.15 | 40.28 |
| d7 | 21.33 | 7.98 | 3.07 |
| d11 | 6.72 | 11.43 | 7.70 |
| d15 | 4.29 | 12.93 | 21.57 |
| d18 | 9.91 | 5.21 | 1.08 |
| d25 | 31.45 | 36.15 | 40.28 |

Lens Unit Data

| Unit | Starting Surface | Focal Length |
|---|---|---|
| 1 | 1 | −30.24 |
| 2 | 8 | 119.72 |
| 3 | 12 | 54.58 |
| 4 | 16 | −50.60 |
| 5 | 19 | 37.67 |

### Second Numerical Example

Unit mm
Surface Data

| Surface Number | r | d | nd | vd |
|---|---|---|---|---|
| 1 | 45.404 | 1.50 | 2.00100 | 29.1 |
| 2 | 19.584 | 7.30 | | |
| 3 | 198.185 | 1.30 | 1.59282 | 68.6 |
| 4 | 39.571 | 3.87 | | |
| 5 | −113.867 | 1.20 | 1.49700 | 81.5 |
| 6 | 24.514 | 5.38 | 1.91082 | 35.2 |
| 7 | 95.965 | (Variable) | | |
| 8 | −76.671 | 1.00 | 1.85478 | 24.8 |
| 9 | 84.843 | 4.45 | 1.85150 | 40.8 |
| 10 | −41.739 | (Variable) | | |
| 11 | 25.047 | 1.00 | 1.83481 | 42.7 |
| 12 | 15.346 | 8.52 | 1.59522 | 67.7 |
| 13* | −99.784 | 1.03 | | |
| 14(Aperture) | ∞ | (Variable) | | |
| 15 | −35.351 | 0.80 | 1.80400 | 46.5 |
| 16 | 31.393 | 1.99 | 1.92286 | 20.9 |
| 17 | 165.712 | (Variable) | | |
| 18 | −1029.479 | 2.83 | 1.49700 | 81.5 |
| 19 | −25.457 | 0.15 | | |
| 20 | 17.370 | 1.20 | 1.91082 | 35.2 |
| 21 | 13.009 | 8.31 | 1.49700 | 81.5 |
| 22 | −36.445 | 0.84 | | |
| 23* | −69.710 | 2.00 | 1.85400 | 40.4 |
| 24* | 26.620 | (Variable) | | |
| 25 | −422.142 | 7.40 | 1.48749 | 70.2 |
| 26 | −28.946 | 2.42 | | |
| 27 | −59.052 | 1.00 | 1.98612 | 16.5 |
| 28 | −201.430 | (Variable) | | |

| | |
|---|---|
| Image Plane | ∞ |

Aspherical Surface Data
13-th Surface
K = 0.00000e+00, A4 = 2.39150e−07, A6 = 2.26158e−09,
A8 = −6.83170e−11
23-th Surface
K = 0.00000e+00, A4 = −8.65880e−06, A6 = −1.40706e−07,
A8 = 8.04703e−10
24-th Surface
K = −2.07769e+00, A4 = 3.72658e−05, A6 = −1.22272e−07,
A8 = 6.54331e−10, A10 = −7.63019e−13, A12 = 2.70504e−15
Various Kinds of Data

| | |
|---|---|
| Zoom Ratio | 2.35 |

| | Wide Angle | Intermediate | Telephoto |
|---|---|---|---|
| Focal Length | 20.61 | 33.00 | 48.39 |
| F-number | 4.10 | 4.10 | 4.10 |
| Half Angle of View | 43.69 | 33.25 | 24.09 |
| Image Height | 19.69 | 21.64 | 21.64 |
| Total Lens Length | 133.51 | 133.51 | 133.51 |
| BF | 12.18 | 12.18 | 12.18 |
| d7 | 23.75 | 7.98 | 2.59 |
| d10 | 5.04 | 10.63 | 5.84 |
| d14 | 2.60 | 12.78 | 22.96 |
| d17 | 11.66 | 6.30 | 1.05 |
| d24 | 12.78 | 18.14 | 23.39 |
| d28 | 12.18 | 12.18 | 12.18 |

Lens Unit Data

| Unit | Starting Surface | Focal Length |
|---|---|---|
| 1 | 1 | −25.64 |
| 2 | 8 | 101.18 |
| 3 | 11 | 42.95 |
| 4 | 15 | −40.56 |
| 5 | 18 | 45.08 |
| 6 | 25 | 229.11 |

### Third Numerical Example

Unit mm
Surface Data

| Surface Number | r | d | nd | vd |
|---|---|---|---|---|
| 1 | 41.061 | 1.50 | 1.76385 | 48.5 |
| 2 | 18.670 | 2.76 | | |
| 3* | 18.742 | 2.00 | 1.58313 | 59.4 |
| 4* | 10.437 | 9.13 | | |
| 5 | −149.551 | 1.20 | 1.49700 | 81.5 |
| 6 | 18.547 | 4.44 | 1.73037 | 32.2 |
| 7 | 54.644 | (Variable) | | |
| 8 | 71.685 | 1.00 | 2.05090 | 26.9 |
| 9 | 35.420 | 2.84 | 1.60311 | 60.6 |
| 10 | −43.164 | (Variable) | | |
| 11 | 21.461 | 1.00 | 1.85478 | 24.8 |
| 12 | 14.791 | 3.77 | 1.58313 | 59.4 |
| 13* | −100.111 | 1.27 | | |
| 14(Aperture) | ∞ | (Variable) | | |
| 15 | −30.974 | 0.80 | 1.69680 | 55.5 |
| 16 | 55.570 | 1.32 | 1.89286 | 20.4 |
| 17 | 341.623 | (Variable) | | |
| 18 | 19.862 | 7.09 | 1.49700 | 81.5 |
| 19 | −28.852 | 0.15 | | |
| 20 | 625.638 | 1.20 | 1.91082 | 35.2 |
| 21 | 61.772 | 4.06 | 1.49700 | 81.5 |
| 22 | −43.596 | 1.27 | | |
| 23* | 43.206 | 1.50 | 1.85400 | 40.4 |
| 24* | 330.721 | (Variable) | | |
| 25 | 150.000 | 3.35 | 1.48749 | 70.2 |
| 26* | −124.136 | 4.44 | | |
| 27 | −40.000 | 1.00 | 1.84666 | 23.8 |
| 28 | −100.000 | (Variable) | | |
| Image Plane | ∞ | | | |

Aspherical Surface Data
Third Surface
K = 0.00000e+00, A4 = 2.80228e−05, A6 = −5.08742e−07,
A8 = 1.42896e−09, A10 = −2.05137e−12
Fourth Surface
K = −2.17472e+00, A4 = 2.22288e−04, A6 = −1.24383e−06,
A8 = 3.19583e−09, A10 = −2.83819e−12
13-th Surface
K = 0.00000e+00, A4 = −9.42621e−06, A6 = −7.89365e−09,
A8 = 4.25537e−10
23-th Surface
K = 0.00000e+00, A4 = −2.15677e−04, A6 = 1.29960e−06,
A8 = −3.41698e−09
24-th Surface
K = −3.17793e+03, A4 = −1.35576e−04, A6 = 1.45714e−06,
A8 = −4.52525e−09, A10 = 5.21835e−12, A12 = 2.70504e−15
26-th Surface
K = 0.00000e+00, A4 = −1.19997e−05, A6 = 6.59284e−10
Various Kinds of Data

| | |
|---|---|
| Zoom Ratio | 1.86 |

| | Wide Angle | Intermediate | Telephoto |
|---|---|---|---|
| Focal Length | 15.47 | 22.61 | 28.82 |
| F-number | 4.10 | 4.10 | 4.10 |
| Half Angle of View | 52.36 | 43.74 | 36.90 |
| Image Height | 20.06 | 21.64 | 21.64 |
| Total Lens Length | 97.47 | 97.47 | 97.47 |
| BF | 11.75 | 11.75 | 11.75 |
| d7 | 13.88 | 4.32 | 1.84 |
| d10 | 2.46 | 6.27 | 3.00 |
| d14 | 1.91 | 7.65 | 13.39 |
| d17 | 9.18 | 3.72 | 0.97 |
| d24 | 1.20 | 6.66 | 9.41 |
| d28 | 11.75 | 11.75 | 11.75 |

Lens Unit Data

| Unit | Starting Surface | Focal Length |
|---|---|---|
| 1 | 1 | −18.56 |
| 2 | 8 | 62.78 |
| 3 | 11 | 36.69 |
| 4 | 15 | −46.28 |
| 5 | 18 | 34.63 |
| 6 | 25 | −200.19 |

### Fourth Numerical Example

Unit mm
Surface Data

| Surface Number | r | d | nd | vd |
|---|---|---|---|---|
| 1* | 104.446 | 1.50 | 1.76450 | 49.1 |
| 2 | 17.760 | 6.57 | | |
| 3 | 130.913 | 0.90 | 1.59282 | 68.6 |
| 4 | 28.342 | 3.64 | | |
| 5 | 4587.402 | 0.90 | 1.49700 | 81.5 |
| 6 | 22.267 | 5.15 | 1.90525 | 35.0 |
| 7 | 86.995 | (Variable) | | |
| 8 | 164.349 | 0.80 | 1.85478 | 24.8 |
| 9 | 32.649 | 0.46 | | |
| 10 | 43.922 | 3.69 | 1.80400 | 46.5 |
| 11* | −51.454 | (Variable) | | |
| 12 | 32.570 | 0.80 | 1.84666 | 23.8 |
| 13 | 23.789 | 4.09 | 1.59522 | 67.7 |
| 14* | −98.723 | 1.47 | | |
| 15(Aperture) | ∞ | (Variable) | | |
| 16* | −28.645 | 0.80 | 1.61340 | 44.3 |
| 17 | 28.022 | 1.86 | 1.92286 | 20.9 |
| 18 | 86.197 | (Variable) | | |
| 19 | 15.506 | 6.28 | 1.49700 | 81.5 |
| 20 | −100.043 | 0.15 | | |
| 21 | 28.845 | 0.80 | 2.00100 | 29.1 |
| 22 | 17.606 | 6.67 | 1.49700 | 81.5 |
| 23 | 56.231 | 2.83 | | |
| 24* | −274.936 | 1.20 | 1.95150 | 29.8 |
| 25* | 65.639 | (Variable) | | |
| 26 | −120.000 | 3.66 | 1.48749 | 70.2 |
| 27 | −28.829 | (Variable) | | |
| Image Plane | ∞ | | | |

Aspherical Surface Data
First Surface
K = 0.00000e+00, A4 = 4.84168e−06, A6 = −4.90718e−09,
A8 = 4.34450e−12
11-th Surface
K = 0.00000e+00, A4 = −4.65434e−06, A6 = −5.76280e−10,
A8 = −8.53780e−11
14-the Surface
K = 0.00000e+00, A4 = −1.53451e−06, A6 = 4.72698e−09,
A8 = −4.93209e−12
16-th Surface
K= 0.00000e+00, A4 = 3.85293e−06, A6 = 2.09562e−08,
A8 = −1.71228e−10
24-th Surface
K = 0.00000e+00, A4 = −5.03054e−04, A6 = 2.71124e−06,
A8 = −3.90281e−09
25-th Surface
K = −1.28237e+02, A4 = −3.64939e−04, A6 = 3.18192e−06,
A8 = −3.10274e−09, A10 = −5.42651e−11, A12 = 4.25542e−13
Various Kinds of Data

| | |
|---|---|
| Zoom Ratio | 2.75 |

| | Wide Angle | Intermediate | Telephoto |
|---|---|---|---|
| Focal Length | 12.37 | 23.99 | 33.97 |
| F-number | 2.35 | 3.03 | 3.60 |
| Half Angle of View | 44.47 | 29.74 | 21.96 |
| Image Height | 12.14 | 13.71 | 13.70 |
| Total Lens Length | 113.77 | 113.77 | 113.77 |
| BF | 11.50 | 11.50 | 11.50 |
| d7 | 25.21 | 4.23 | 1.66 |
| d11 | 3.73 | 13.04 | 3.94 |
| d15 | 2.53 | 14.20 | 25.87 |
| d18 | 13.96 | 4.43 | 1.10 |
| d25 | 2.64 | 12.16 | 15.49 |
| d27 | 11.50 | 11.50 | 11.50 |

Lens Unit Data

| Unit | Starting Surface | Focal Length |
|---|---|---|
| 1 | 1 | −22.31 |
| 2 | 8 | 74.95 |
| 3 | 12 | 47.02 |
| 4 | 16 | −47.22 |
| 5 | 19 | 36.74 |
| 6 | 26 | 76.83 |

TABLE 1

| | First | Second | Third | Fourth |
|---|---|---|---|---|
| | Exemplary | Exemplary | Exemplary | Exemplary |
| | Embodiment | Embodiment | Embodiment | Embodiment |
| (1) | 0.886 | 1.027 | 0.778 | 1.904 |
| M2/fw | | | | |
| (2) | 1.079 | 1.059 | 0.793 | 0.996 |
| \|f3/f4\| | | | | |
| (3) | 1.526 | 0.591 | 0.760 | 0.930 |
| BFw/fw | | | | |
| (4) | 1.468 | 1.244 | 1.200 | 1.804 |
| \|f1/fw\| | | | | |
| (5) | 5.810 | 4.909 | 4.059 | 6.060 |
| f2/fw | | | | |
| (6) | 2.649 | 2.084 | 2.372 | 3.802 |
| f3/fw | | | | |
| (7) | 2.456 | 1.968 | 2.992 | 3.817 |
| \|f4/fw\| | | | | |
| (8) | 1.828 | 2.187 | 2.239 | 2.970 |
| f5/fw | | | | |
| (9) | 0.803 | 0.569 | 0.536 | 0.607 |
| \|f1/f5\| | | | | |
| (10) | 0.598 | 0.632 | 0.401 | 0.472 |
| \|f1/f4\| | | | | |
| (11) | 0.839 | 0.988 | 0.742 | 1.888 |
| M3/fw | | | | |
| (12) | 0.429 | 0.515 | 0.531 | 1.039 |
| M5/fw | | | | |
| (13) | 1.460 | 1.545 | 1.579 | 2.039 |
| βFt/βF | | | | |
| w | | | | |
| (14) | 1.004 | 1.060 | 0.979 | 1.015 |
| βRt/βR | | | | |
| w | | | | |
| (15) | 0.557 | 0.474 | 0.465 | 0.762 |
| DSPL4t/ | | | | |
| ft | | | | |

### [Imaging Apparatus]

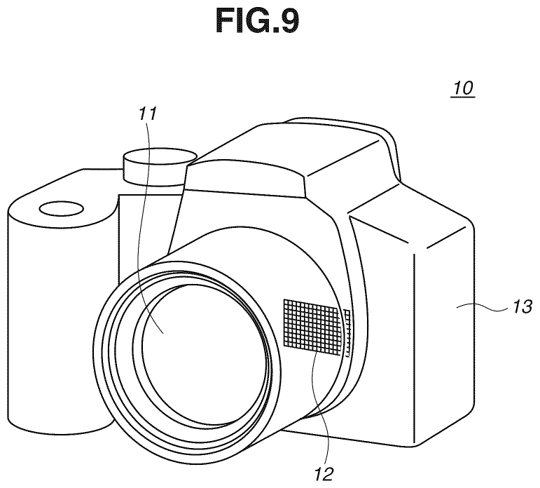

An exemplary embodiment of a digital still camera (imaging apparatus) using the zoom lens L0 according to any of the exemplary embodiments as an imaging optical system is described with reference to FIG. 9. In FIG. 9, a reference numeral 10 indicates the digital still camera (imaging apparatus), a reference numeral 13 indicates a camera main body, and a reference numeral 11 is an imaging optical system including the zoom lens according to any of the first to fourth exemplary embodiments.

A reference numeral 12 indicates a solid-state image pickup device (photoelectric conversion device), such as a CCD sensor and a CMOS sensor, incorporated in the camera main body 13 and receiving and photoelectrically converting an optical image formed by the imaging optical system 11. The camera main body 13 may be what is called a single-lens reflex camera including a quick return mirror, or what is called a mirrorless camera not including the quick return mirror.

The zoom lens according to any of the exemplary embodiments is applied to the imaging apparatus, such as a digital still camera, in the above-described manner, which makes it possible to provide the imaging apparatus having a small lens.

### [Imaging System]

An imaging system (monitoring camera system) that includes the zoom lens L0 according to any of the first to fourth exemplary embodiments and a control unit controlling the zoom lens L0 may be configured. In this case, the control unit can control the zoom lens such that each of the lens units is moved as described above in zooming, focusing, and image shake correction.

At this time, the control unit is not required to be integrally configured with the zoom lens, and the control unit may be configured separately from the zoom lens. For example, the control unit (control apparatus) disposed at a place far from a driving unit driving each of the lenses of the zoom lens may include a transmission unit transmitting a control signal (instruction) for controlling the zoom lens. Such a control unit can remotely operate the zoom lens.

Further, an operation unit, such as a controller and a button, for remotely operating the zoom lens may be provided in the control unit to control the zoom lens in response to an input to the operation unit by a user. For example, as the operation unit, an enlargement button and a reduction button may be provided. At this time, the control unit is configured to transmit the signal to the driving unit of the zoom lens such that a magnification of the zoom lens is increased in response to a press of the enlargement button by the user, and the magnification of the zoom lens is reduced in response to a press of the reduction button by the user.

The imaging system may further include a display unit, such as a liquid crystal panel, displaying information about zoom (moving state) of the zoom lens. The information about zoom of the zoom lens is, for example, a zoom magnification (zoom state) and a moving amount (moving state) of each of the lens units. In this case, the user can remotely operate the zoom lens via the operation unit while viewing the information about zoom of the zoom lens displayed on the display unit. At this time, for example, a touch panel may be adopted so that the display unit and the operation unit are integrated.

Although the exemplary embodiments and the numerical examples of the disclosure are described above, the disclosure is not limited to the exemplary embodiments and the numerical examples, and various combinations, modifications, and changes can be made within the scope of the spirit of the disclosure.

According to the exemplary embodiments, it is possible to provide the small zoom lens having high optical performance.

While the embodiments of the disclosure have been described above, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-178514, filed Oct. 16, 2023, which is hereby incorporated by reference herein in its entirety.

What is claimed is:

1. A zoom lens comprising, in order from an object side to an image side:
a first lens unit having negative refractive power;
a second lens unit having positive refractive power;
a third lens unit having positive refractive power;
a fourth lens unit having negative refractive power; and
a fifth lens unit having positive refractive power,
wherein an interval between the lens units adjacent to each other is changed in zooming, and
wherein the first lens unit and the fourth lens unit are not moved in zooming.

2. The zoom lens according to claim 1, wherein a following inequality is satisfied:
0.45<M2/fw<4.50,
where M2 is an absolute value of a moving amount of the second lens unit on an optical axis in zooming from a wide angle end to a telephoto end, and fw is a focal length of an entire system at the wide angle end when focus is at infinity.

3. The zoom lens according to claim 1, wherein a following inequality is satisfied:
0.00<|f3/f4|<1.70,
where f3 is a focal length of the third lens unit, and f4 is a focal length of the fourth lens unit.

4. The zoom lens according to claim 1, further comprising an aperture stop,
wherein a following inequality is satisfied:
0.20<DSPL4t/ft<1.50,
where DSPL4t is a distance from the aperture stop to a surface of the fourth lens unit on a most object side on an optical axis, and ft is a focal length of an entire system at a telephoto end when focus is at infinity.

5. The zoom lens according to claim 1, wherein a following inequality is satisfied:
$$0.7 < β Ft / β Fw < 4.1 ,$$
where βFw is a combined lateral magnification of the second lens unit and the third lens unit at a wide angle end, and βFt is a combined lateral magnification of the second lens unit and the third lens unit at a telephoto end.

6. The zoom lens according to claim 1, wherein a following inequality is satisfied:
$$0.3 < BFw / fw < 3.1 ,$$
where BFw is a back focus at a wide angle end when focus is at infinity, and fw is a focal length of an entire system at the wide angle end when focus is at infinity.

7. The zoom lens according to claim 1, wherein a following inequality is satisfied:
$$0.6 < \vert f 1 / fw \vert < 3.6 ,$$
where f1 is a focal length of the first lens unit, and fw is a focal length of an entire system at the wide angle end when focus is at infinity.

8. The zoom lens according to claim 1, wherein a following inequality is satisfied:
$$2. < f 2 / fw < 12.1 ,$$
where f2 is a focal length of the second lens unit, and fw is a focal length of an entire system at the wide angle end when focus is at infinity.

9. The zoom lens according to claim 1, wherein a following inequality is satisfied:
$$1. < f 3 / fw < 7.6 ,$$
where f3 is a focal length of the third lens unit, and fw is a focal length of an entire system at the wide angle end when focus is at infinity.

10. The zoom lens according to claim 1, wherein a following inequality is satisfied:
$$1. < \vert f 4 / fw \vert < 7.6 ,$$
where f4 is a focal length of the fourth lens unit, and fw is a focal length of an entire system at the wide angle end when focus is at infinity.

11. The zoom lens according to claim 1, wherein a following inequality is satisfied:
$$0.9 < f 5 / fw < 5.9 ,$$
where f5 is a focal length of the fifth lens unit, and fw is a focal length of an entire system at the wide angle end when focus is at infinity.

12. The zoom lens according to claim 1, wherein a following inequality is satisfied:
$$0.3 < \vert f 1 / f 5 \vert < 1.6 ,$$
where f1 is a focal length of the first lens unit, and f5 is a focal length of the fifth lens unit.

13. The zoom lens according to claim 1, wherein a following inequality is satisfied:
$$0.2 < \vert f 1 / f 4 \vert < 1.3 ,$$
where f1 is a focal length of the first lens unit, and f4 is a focal length of the fourth lens unit.

14. The zoom lens according to claim 1, wherein a following inequality is satisfied:
$$0.4 < M 3 / fw < 3.8 ,$$
where M3 is an absolute value of a moving amount of the third lens unit on an optical axis in zooming from a wide angle end to a telephoto end, and fw is a focal length of an entire system at the wide angle end when focus is at infinity.

15. The zoom lens according to claim 1, wherein a following inequality is satisfied:
$$0.2 < M 5 / fw < 2.1 ,$$
where M5 is an absolute value of a moving amount of the fifth lens unit on an optical axis in zooming from a wide angle end to a telephoto end, and fw is a focal length of an entire system at the wide angle end when focus is at infinity.

16. The zoom lens according to claim 1, wherein a following inequality is satisfied:
$$0.5 < β Rt / β Rw < 2.1 ,$$
where βRw is a combined lateral magnification of the lens units disposed on the image side relative to the third lens unit at a wide angle end, and βRt is a combined lateral magnification of the lens units disposed on the image side relative to the third lens unit at a telephoto end.

17. The zoom lens according to claim 1,
wherein the third lens unit includes an aperture stop, and
wherein the third lens unit and the aperture stop are integrally moved in zooming.

18. The zoom lens according to claim 1, wherein the second lens unit is moved in focusing from infinity to a close distance.

19. The zoom lens according to claim 1, wherein the first lens unit is not moved in focusing from infinity to a close distance.

20. The zoom lens according to claim 1, wherein the first lens unit includes three negative lenses.

21. The zoom lens according to claim 1, wherein the fourth lens unit includes a negative lens with a concave surface facing the object side.

22. The zoom lens according to claim 1, wherein the fifth lens unit includes two positive lenses.

23. An imaging apparatus, comprising:
the zoom lens according to claim 1; and
an imaging device configured to receive an image formed by the zoom lens.
